(19) United States
(12) Patent Application Publication
(10) Pub. No.: US 2008/0273429 A1
(43) Pub. Date: Nov. 6, 2008

(54) CASSETTE ADAPTER FOR A VEHCILE

(76) Inventor: Maurice S. Dayan, Oakhurst, NJ (US)

Correspondence Address: BUCHANAN, INGERSOLL & ROONEY PC, POST OFFICE BOX 1404, ALEXANDRIA, VA, 22313-1404, US

(21) Appl. No.: 12/061,507

(22) Filed: Apr. 2, 2008

Related U.S. Application Data
(60) Provisional application No. 60/909,498, filed on Apr. 2, 2007.
(60) Provisional application No. 60/939,129, filed on May 21, 2007.

(51) Int. Cl. G11B 23/04

(52) U.S. Cl. 369/2

(57) ABSTRACT

A audio player adapter for a vehicle. The audio player adapter is adapted to be connected to the vehicle via the cassette playing portion of the vehicle. The audio player adapter is capable of accommodating a variety of different audio playing devices.

### CROSS REFERENCE TO RELATED APPLICATIONS

The present application claims the benefit of U.S. Provisional Application Ser. No. 60/909,498, filed on Apr. 2, 2007, and U.S. Provisional Application Ser. No. 60/939,129, filed on May 21, 2007, the entireties of which are herby incorporated by reference.

### FIELD OF THE INVENTION

This invention relates to the field of vehicle audio players. In particular, the invention relates to an apparatus for providing audio information in a vehicle.

### BACKGROUND OF THE INVENTION

There are a variety of devices that are able to reproduce audio data. The different types of audio playing devices has increased over time. Audio data can be stored in different formats and media, such as on optical disks, magnetic disks, MP3 formats, etc. The different ways in which audio information may be stored and played frequently outpaces the way in which vehicles are equipped to reproduce the audio information.

Many vehicles come equipped with only one or two types of media playing devices. In order to play media stored on newer types of devices an individual frequently has to install a new audio playing device. However, installing a new audio playing device is time consuming and costly. Additionally, portable units have been used, but frequently do not accommodate a wide variety of different audio playing devices.

Therefore there is a need in the field to provide an adapter that is capable of easily connecting various different audio playing devices to a vehicle.

### SUMMARY OF THE INVENTION

It is therefore an object of the invention to provide an adapter for permitting audio playing devices to be played in a vehicle.

Another object of the invention is to provide a device with the ability to connect a device that uses a USB connector to a vehicle's stereo system.

Yet another object of the invention is to provide a device that uses the cassette player located within a vehicle.

Another object of the invention is to provide a device that can connect to a variety of different audio players.

Yet another object of the invention is to provide an audio playing device that can connect through the cassette player in a vehicle.

In accordance with these and other objects of the invention a first aspect of invention can be an adapter for use with vehicles comprising: a housing adapted for insertion into a cassette player; a cable connected to the housing wherein when the housing is inserted into the cassette player the cable extends from the cassette player; and a plurality of connectors located at a distal end of the cable, wherein at least one of the plurality of connectors is a USB connector.

A second aspect of the invention can be an adapter for use with vehicles comprising: a housing adapted for insertion into a cassette player; a controller located within the housing and adapted for receiving audio data from an external audio playing device; a cable connected to the housing, wherein when the housing is inserted into the cassette player the cable extends from the cassette player; a plurality of wires extending from the cable; and a plurality of connectors attached to the plurality of wires, wherein at least one of the plurality of connectors is a USB connector.

A third aspect of the invention can be an adapter for use with vehicles comprising: a cassette shaped housing having a cable extending therefrom; a media controller connected to the cable; a 12 V plug extending from the media controller; and a USB port located on the media controller.

A fourth aspect of the invention can be a method for playing audio files in a vehicle comprising: placing a cassette housing into a cassette player located within a vehicle; placing a media controller into a cigarette lighter within a vehicle, wherein a cable is connected from the cassette housing to the media controller; playing audio data through a stereo system of the vehicle.

### BRIEF DESCRIPTION OF THE DRAWINGS

FIG. 1 is a perspective view of the cassette adapter in accordance with an embodiment of the present invention.

FIG. 2 is component diagram of the cassette adapter in accordance with the embodiment shown in FIG. 1.

FIG. 3 is a perspective view of the cassette adapter according to a second embodiment of the present invention.

FIG. 4 is a component diagram of the cassette adapter in accordance with the embodiment shown in FIG. 3.

FIG. 5a is a top view of locations for the cable 12.

FIG. 5b is rear view of locations for the cable 12.

### DETAILED DESCRIPTION OF THE DRAWINGS

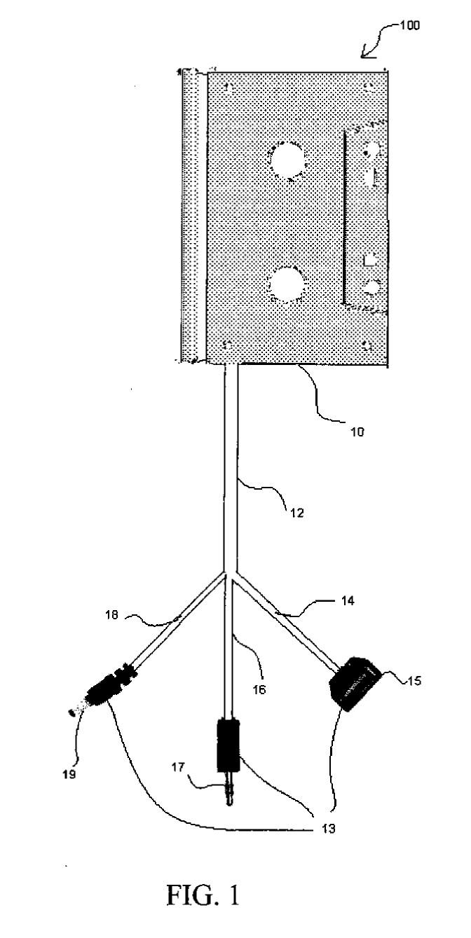

A cassette adapter 100 is shown in FIG. 1. The cassette adapter 100 has a cassette housing 10 that is shaped and arranged so as to be capable of being inserted into a vehicle's cassette player. The cassette housing 10 interacts with the vehicle cassette player in a manner known to those of ordinary skill in the art.

In the embodiment shown in FIG. 1, extending from a side of the cassette housing 10 is a cable 12. The cable 12 is located on the cassette housing 10 in such a manner so as to permit the cable 12 to extend from the opening of the vehicle's cassette player when the cassette housing 10 is inserted into the vehicle's cassette player. When the cable 12 extends from the vehicle's cassette player, the cable 12 is accessible by an individual in order to use it to operably connect an external audio playing device to the cassette adapter 100.

Still referring to FIG. 1, the cassette adapter 100 further comprises three connectors 13. The connectors are positioned at the distal end of three wires 14, 16, 18. More specifically, extending from the distal end of the cable 12 are the wires 14, 16 and 18. At the end of each wire 14, 16, 18 is a connector 13. Although three wires 14, 16 and 18 having a connector 13 are shown in FIG. 1, it should be understood that it is possible to use more or less wires depending upon the anticipated needs of the cassette adapter 100.

The connectors 13 are located at the end of the cable 12 are attached to the ends of each of the wires 14, 16, and 18. The connectors 13, may be a variety of different plugs and/or devices for connection to an external audio playing device. In the embodiment shown in FIG. 1 there are three connectors 13 shown. A 12 V DC plug 19 is attached to the wire 18, which extends from the cable 12. A 3.5 mm stereo audio plug 17 is attached to the wire 16, which extends from the cable 12. A full size USB connector 15 is attached to the wire 14, which also extends from the cable 12. The USB connector 15 may either accommodate the insertion of a USB plug, or alternatively be a USB port for receiving a USB plug.

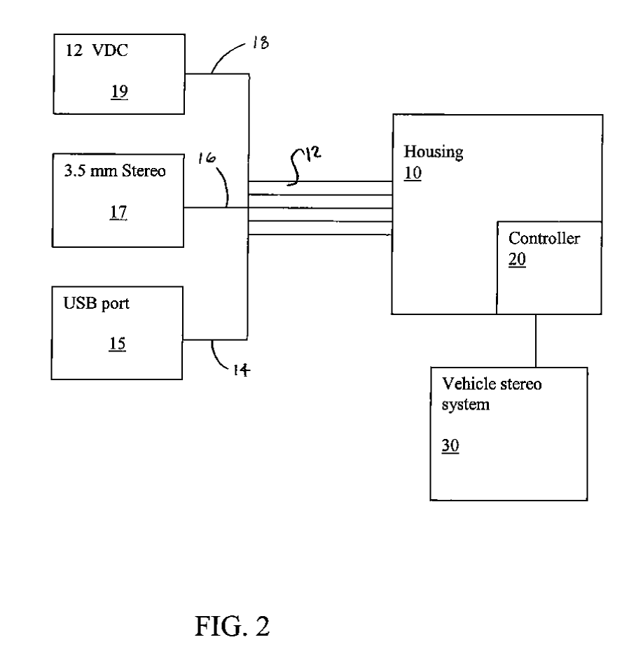

Now referring to FIG. 2, a diagram illustrating the components of the cassette adapter 100 is shown. The wires 14, 16 and 18 are contained within the cable 12, which extends into the cassette housing 10 of the cassette adapter 100. The wires 14, 16, and 18 are operably connected to the controller 20 through the cable 12. When an external audio playing device is connected to one of the connectors 13, it transmits signals through whichever one of the wires 14, 16 and 18 is appropriate.

Each of the connectors 13 are adapted for connection to a different type of external audio playing device and can be connected to various ports jacks and plugs located on the external audio playing device. It should be understood that in some embodiments it is not necessary that the device to which the cassette adapter 100 is attached be an audio playing device, and instead may be a video playing device, or other media reproducing device that utilizes audio files. In some instances the external device may be a digital data storage device that is able to store audio files, such as a memory stick.

The controller 20 processes the audio data received from the external audio playing devices and transmits the audio data to the vehicle stereo system 30. In some embodiments the controller 20 is capable of receiving and processing audio data from a variety of different sources (e.g. CD player, MP3 player, etc.) and different formats (e.g. WAV, MP3, etc.). The processed audio data is then played through the vehicle stereo system 30. In some embodiments the controller 20 may also be capable of interpreting the control signals that are received through usage of the controls of the vehicle stereo system 30. Some embodiments may permit the usage of either the controls on an external audio playback device and/or the vehicle stereo system 30. In the embodiment shown in FIG. 1, playback is controlled through the controls of an external audio playback device.

The external audio playback device when used in conjunction with the cassette adapter 100 is typically powered through the use of batteries or may be powered through the use of a 12 V adapter attached to the external audio playing device. A second embodiment of the cassette adapter 100 is discussed below that is capable of providing power to the external audio playback device through a vehicle's power system.

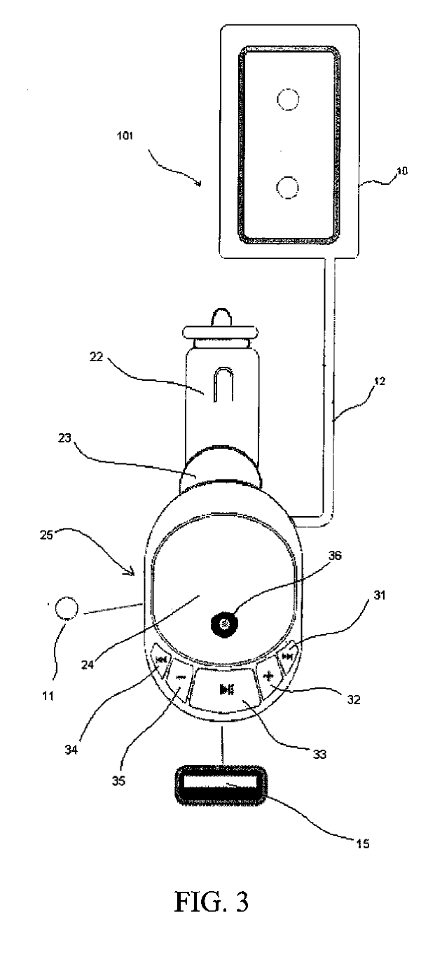

FIG. 3 is a perspective view of a cassette adapter 101 according to a second embodiment of the present invention. The cassette adapter 101 does not use the connectors 13 and wires 14, 16 and 18 used with the cassette adapter 100 as shown and discussed above with respect to FIG. 1. The cassette adapter 101 comprises a media controller 24 connected to a cassette housing 10 via a cable 12.

The media controller 24 comprises a head portion 25, a 12 V DC plug 22 and pivotal connector 23. The 12 V DC plug 22 is adapted for insertion into a vehicle's cigarette lighter. The 12 V DC plug 22, when connected to a vehicle's cigarette lighter, provides energy to the media controller 24, which in turn can provide energy to an external audio playback device or to a device that can store audio data such as a memory stick, etc.

The pivotal connector 23 is connected to the end of the 12 V DC plug 22 that is not placed into the cigarette lighter. When the 12 V DC plug 22 is connected to a vehicle's cigarette lighter, the 12 V DC plug 22 is stationary. The pivotal connector 23 permits the head portion 25 of the media controller 24 to be adjusted with respect to the cigarette 12 V DC plug 22. This permits the head portion 25 to be located in a position that is easy to access by an individual while operating a vehicle.

The head portion 25 houses the electronics that are capable of manipulating the audio data that is transmitted from an external media player and/or the electronics stored therein for storing and reproducing audio data. Located on a top portion of the head portion 25 are a series of controls. The controls are used for adjusting the playback of the audio data. Play/pause button 33 is used for playing or pausing playback of audio data. Volume up button 32 increases the volume of audio data playback. Volume down button 35 decreases the volume of audio playback. Rewind button 34 rewinds the playback of the audio data. Fast forward button 31 forwards the playback of the audio data. The controls described are for exemplary purposes only and are not intended to be limiting of the present invention unless specifically claimed. Similarly, the shape, size and positioning of the controls is also not limiting of the invention.

The cassette adapter 101 further comprises a 3.5 mm audio port 11 is located on the side of the head portion 25. The 3.5 mm audio port 11 can receive an audio cable from an external media playing device. A USB port 15 is located on the front underside of the head portion 25 and can receive USB plugs. On top of the head portion 25 is a LED light 36 that indicates when the 12 V DC plug is properly inserted into a 12 DC socket and being supplied power.

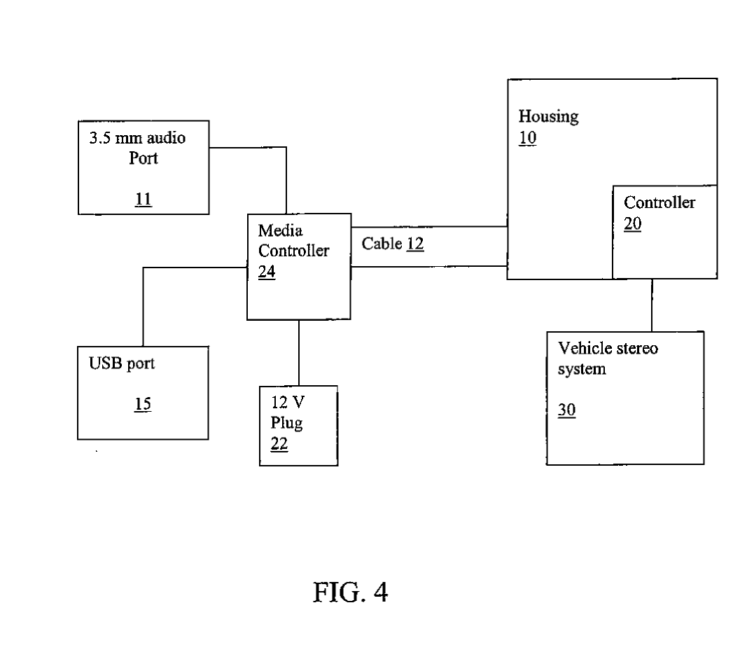

FIG. 4 is a diagram illustrating the components of the cassette adapter 101. The cable 12 extends from the media controller 24 into the cassette housing 10 of the cassette adapter 101. The cable 12 may be operably connected to the controller 20 or alternatively connected to the internal components of the cassette housing 10 that permits audio data to be played through the vehicle stereo system 30.

As part of the media controller 24 there is a USB port 15 and an audio port 11. The USB port 15 and the audio port 11 are operably connected to the media controller 24. Different types of external audio playing devices can be connected to the media controller 24 though the ports. It should be understood that in some embodiments it is not necessary that the device to which the cassette adapter 101 is attached be an audio playing device, and instead may be video playing device, or other media reproducing device that utilizes audio files. In some instances the external device may be a digital data storage device that is able to store audio files, such as a memory stick. In alternative embodiments the media controller 24 may store and process the audio data itself. In these embodiments the stored audio files may be transmitted from the media controller 24 directly to the controller 20 located within the cassette housing 10.

Still referring to FIG. 4, the controller 20 processes the audio data received from the external audio playing devices or from the media controller 24 and transmits the audio data to the vehicle stereo system 30. In some embodiments the controller 20 is capable of receiving and processing audio data from a variety of different sources (e.g. CD player, MP3 player, etc.) and different formats (e.g. WAV, MP3, etc.). The processed audio data is then played through the vehicle stereo system 30. Furthermore, some embodiments provide that the controller 20 may also be capable of interpreting the control signals that are received through usage of the controls of the vehicle stereo system 30. Alternatively, some embodiments may permit the usage of either the controls on external audio playback devices, the media controller 24 and/or the vehicle stereo system 30. In the embodiment shown in FIG. 4 playback is controlled through the controls located on the media controller 24 and discussed above.

Still referring to FIG. 4. The 12 V plug 22 is able to provide power to the media controller 24. Power can also be supplied to an external audio playback device through the ports.

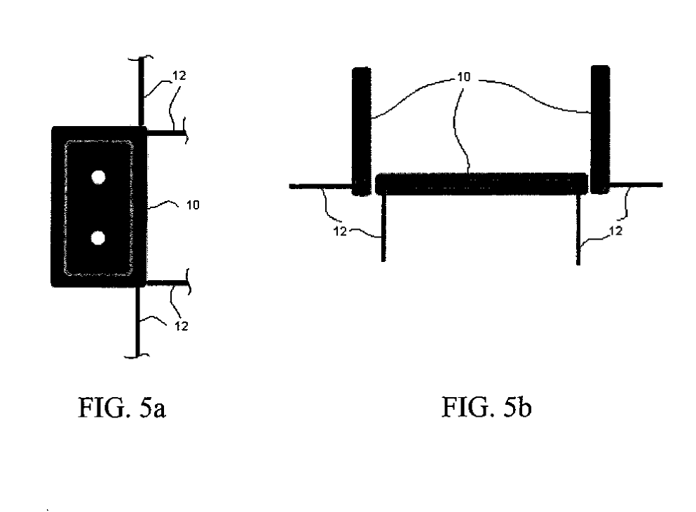

FIGS. 5a and 5b illustrate where the cable 12 can be placed with respect to the cassette 10. As shown in FIGS. 5a and 5b, the cable 12 may be located so that it can extend from any direction from the corner when placed within a cassette player.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. An adapter for use with vehicles comprising:
a housing adapted for insertion into a cassette player;
a cable connected to the housing wherein when the housing is inserted into the cassette player the cable extends from the cassette player; and
a plurality of connectors located at a distal end of the cable, wherein at least one of the plurality of connectors is a USB connector.

2. The adapter of claim 1 wherein the plurality of connectors further comprise a 12 V DC plug and a 3.5 mm stereo audio plug.

3. The adapter of claim 1, wherein a plurality of wires are located within the cable.

4. An adapter for use with vehicles comprising:
a housing adapted for insertion into a cassette player;
a controller located within the housing and adapted for receiving audio data from an external audio playing device;
a cable connected to the housing, wherein when the housing is inserted into the cassette player the cable extends from the cassette player;
a plurality of wires extending from the cable; and
a plurality of connectors attached to the plurality of wires, wherein at least one of the plurality of connectors is a USB connector.

5. The adapter of claim 4, wherein the plurality of connectors further comprise a 12 V DC plug and a 3.5 mm stereo audio plug.

6. An adapter for use with vehicles comprising:
a cassette shaped housing having a cable extending therefrom;
a media controller connected to the cable;
a 12 V plug extending from the media controller; and
a USB port located on the media controller.

7. The adapter of claim 6, further comprising a pivotal support connected to the media controller and further connected to the 12 V plug.

8. The adapter of claim 6, further comprising an audio port located on a side of the media controller.

9. A method for playing audio files in a vehicle comprising:
placing a cassette housing into a cassette player located within a vehicle;
placing a media controller into a cigarette lighter within a vehicle, wherein a cable is connected from the cassette housing to the media controller;
playing audio data through a stereo system of the vehicle.

10. The method of claim 9, wherein the playing of the audio data is controlled by the media controller.

11. The method of claim 9, wherein the playing of the audio data is controlled by the vehicle.

12. The method of claim 9, further comprising connecting an audio data storage device to the media controller.

13. The method of claim 12, wherein the audio data is transmitted from the audio data storage device through the media controller and to the cassette housing.

14. The method of claim 12, wherein the audio data storage is connected to the media controller through a USB port.
